(19) United States
(12) Patent Application Publication
(10) Pub. No.: US 2003/0176100 A1
(43) Pub. Date: Sep. 18, 2003

(54) Electrical device having a DC electrical outlet

(76) Inventors: John T. Yurek, Los Angeles, CA (US); Patrick McCabe, Granada Hills, CA (US)

Correspondence Address: SHELDON & MAK, 9th Floor, 225 South Lake Avenue, Pasadena, CA, 91101, US

(21) Appl. No.: 10/071,162

(22) Filed: Feb. 7, 2002

(51) Int. Cl. H01R 13/60

(52) U.S. Cl. 439/535

(57) ABSTRACT

A combination has a body structure, an electrical input element for connecting the body structure to a source of alternating current electricity and a low voltage DC electrical female outlet. The combination can also have a standard AC electrical outlet. The combination can also comprise an ordinary household or office consumer product, such as an ordinary household or office electrical consumer product.

### FIELD OF THE INVENTION

This invention relates generally to electrical devices having electrical outlets and, more specifically, to electrical devices having a DC outlet.

### BACKGROUND OF THE INVENTION

For more than 100 years, the use of alternating current (AC) electrical power has been a mainstay in virtually every commercial establishment and private residence. Within the last several years, the use of direct current (DC) electrical power has also become important in industrial establishments and private residences. This is because low voltage DC electrical power is becoming increasingly important in the powering of electronic devices and in the recharging of batteries which power electronic devices.

Unfortunately, the rising need for many AC and DC electrical outlets has resulted in problems regarding the undue amount of physical space required of so many outlets and regarding the relatively unsightly nature of so many outlets.

Accordingly, there is a need for an electrical outlet device which avoids such physical space and aesthetic problems.

### SUMMARY

The invention satisfies this need. The invention is a combination comprising (a) a body structure, (b) an electrical input element for connecting the body structure to a source of alternating current electricity, and (c) a low voltage DC electrical female outlet disposed within the body structure and adapted to provide low voltage DC electricity to an electrical device plugged into the low voltage DC electrical female outlet when the electrical input element is electrically connected to a source of electrical power.

In one typical embodiment, the invention further comprises a standard AC electrical outlet disposed within the body structure, the standard AC electrical outlet being connected in electrical communication with the electrical input element and being adapted to provide AC electricity to an electrical device plugged into the standard AC electrical outlet when the electrical input element is electrically connected to a source of electrical power.

In another typical embodiment, the body structure comprises an ordinary household or office consumer product.

### DRAWINGS

These features, aspects and advantages of the present invention will become better understood with regard to the following description, appended claims and accompanying figures where:

FIG. 1 is an isometric view of a combination having features of the invention;

FIG. 2 is an isometric view of a first component of the invention illustrated in FIG. 1;

FIG. 3 is an isometric view of a second component of the combination illustrated in FIG. 1;

FIG. 4 is an underside isometric view of the second component illustrate din FIG. 3;

FIG. 5 is an isometric top side view of a third component of the combination illustrated in FIG. 1;

FIG. 6 is an isometric top view of a fourth component of the combination illustrated in FIG. 1;

FIG. 7 is an isometric view of a second combination having features of the invention;

FIG. 8 is an isometric view of a third combination having features of the invention;

FIG. 9 is a side view of a fourth combination having features of the invention;

FIG. 10 is a top view illustrating the useable of the combination of FIG. 9; and

FIG. 11 is a side view of a fifth combination having features of the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a combination 10 comprising a body structure 12, an electrical input element 14 and a low voltage DC female outlet 18.

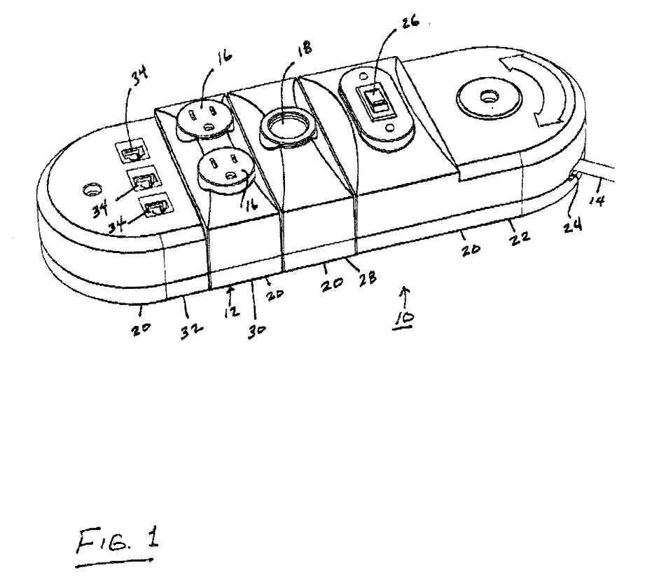

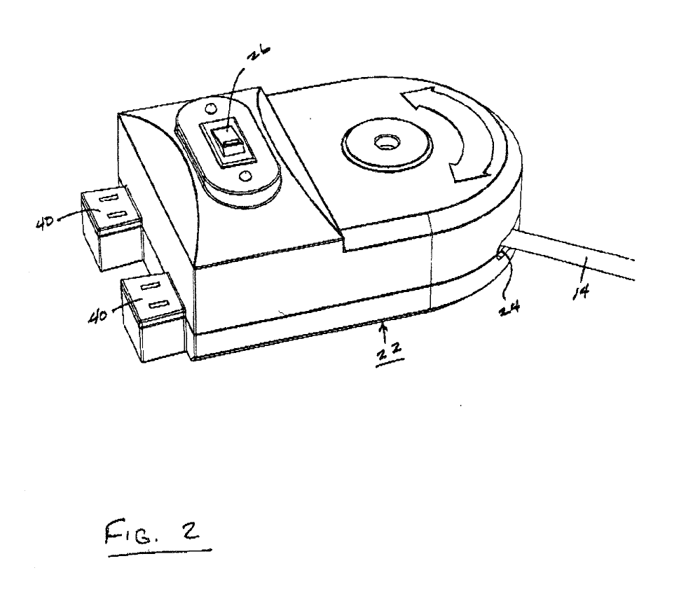

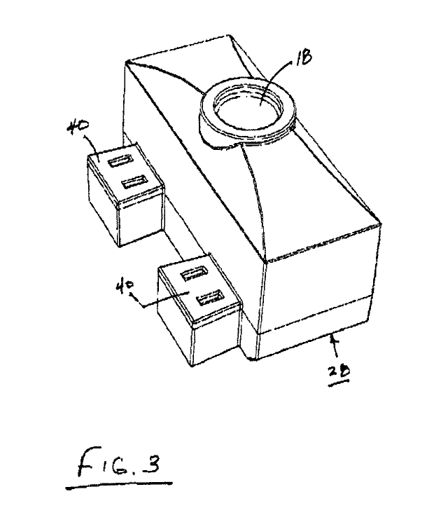

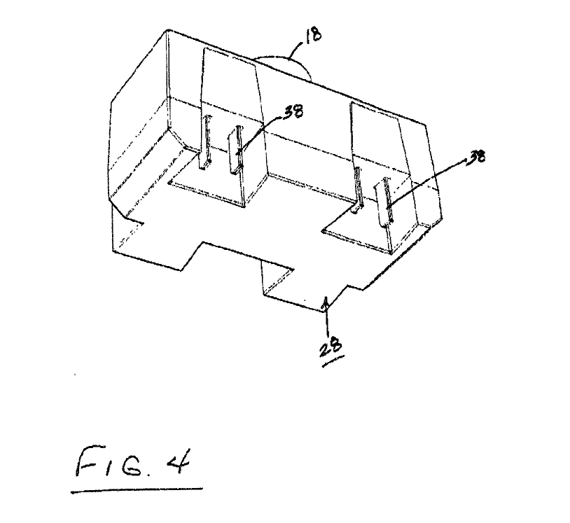

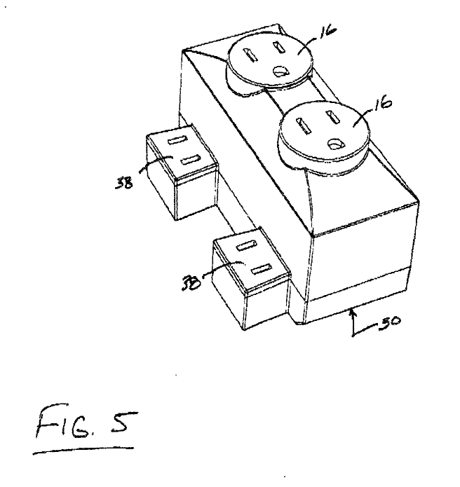

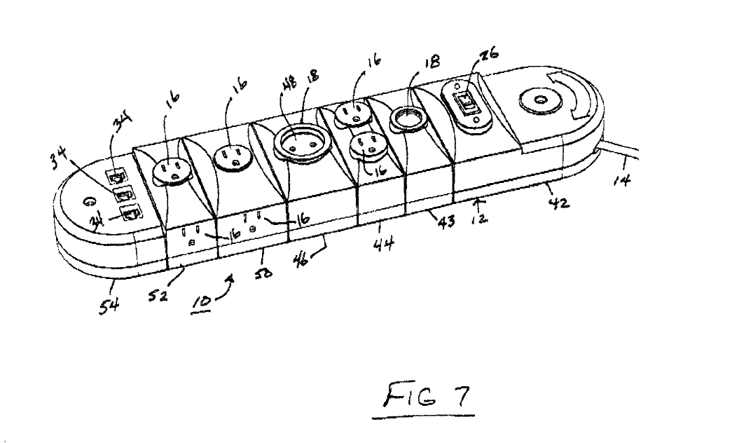

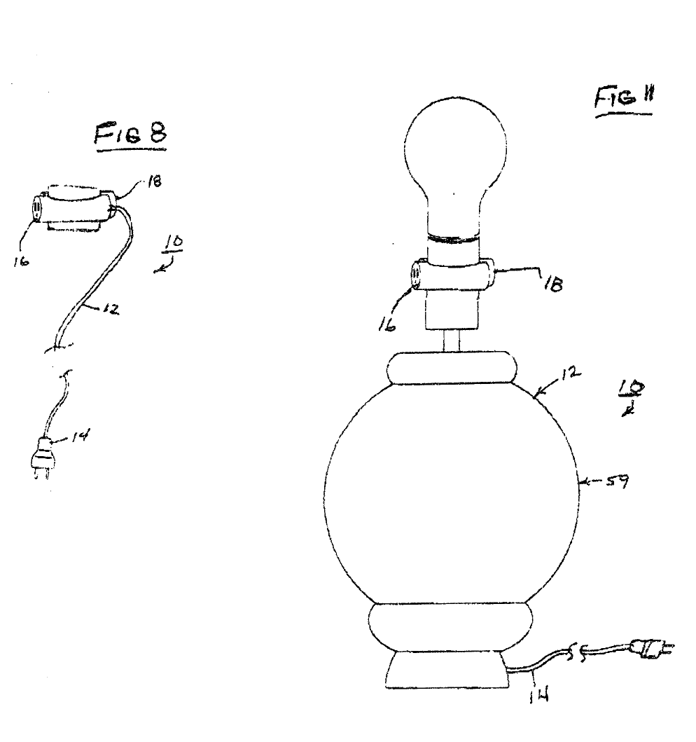

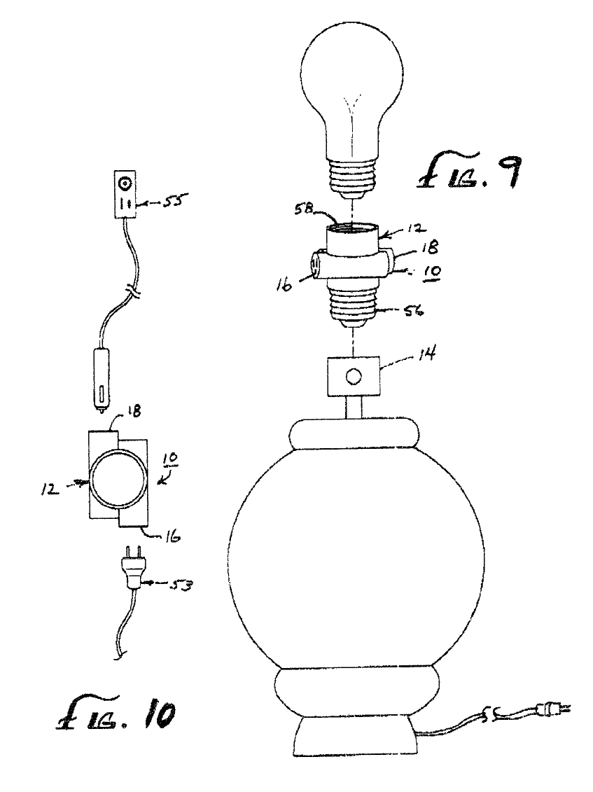

The body structure 12 can have any of a large number of convenient shapes. FIGS. 1-6 illustrate an embodiment wherein the body structure is a bus bar. In the embodiment illustrated in FIG. 8, the body structure 12 is an extension cord. In the embodiment illustrated in FIGS. 9 and 10, the body structure 12 is a light bulb connection element. In the embodiment illustrated in FIG. 11, the body structure 12 is a table lamp. Many other shapes and functions are also possible for the body structure 12.

FIGS. 1-6 illustrate a typical embodiment wherein the body structure 12 is a bus bar. In the embodiment illustrated in FIG. 1, the body structure 12 is comprised of a plurality of module units 20. The first module unit 22 comprises an electrical input element 14 in the form of an electrical extension cord. In the embodiment illustrated in the drawings, the electrical input element 14 is adapted to swivel within the body structure 12 through a body structure groove 24. In a typical embodiment, the electrical input element 14 can swivel through an arc of about 90°.

Disposed within the first module unit 22 can be electrical circuitry known in the art to adapt the combination 10 to act as a surge suppressor.

The first module unit 22 also includes an on-off switch 26 capable of alternatively switching electrical power on and off to the other module units 20.

A second module unit 28 in the embodiments illustrated in FIGS. 1-6 comprises a low voltage DC female outlet 18. This low voltage DC female outlet 18 is adapted to provide low voltage DC electricity to an electrical device plugged into the low voltage DC electrical female outlet 18 when the electrical input element 14 is connected to a source of electrical power. By “low voltage,” it is meant a voltage less than about 25 volts, typically less than 15 volts and most typically between about 5 and about 15 volts. For example, the low voltage DC electrical female outlet 18 can be used to power a cellular phone or other electronic communications device by plugging in a male DC electrical connector of the communications device into the low voltage DC electrical female outlet 18 in the second module unit 28. Also, the low voltage DC electrical female outlet 18 can be used to recharge batteries of a wide variety of electronic communications equipment and other electronic equipment using low voltage DC electrical power.

In the embodiment illustrated in FIGS. 1-6, a third module unit 30 comprises a pair of standard AC electrical outlets 16. The standard AC outlets 16 can be either male or female in form. Each standard AC electrical outlet 16 is connected in electrical communication with the electrical input element 14 and is adapted to provide AC electricity to an AC power-using electrical device when that device is plugged into the standard AC electrical outlet 16.

A fourth module unit 32 in the embodiment illustrated in FIGS. 1-6 comprises several telephone jack receptacles 34. The term “telephone jack receptacle” as used herein is meant to be construed broadly to mean a kind of electrical connection having features of a typical telephone jack receptacles, but which can have many uses, including uses for voice input and output and for data input and output.

Each of the module units 20 is electrically and physically attached to adjoining module units by plug-and-socket connections, such as by the dual male plug 38 and dual female socket component 40 illustrated in the drawings. Other forms of plug-and-socket connections can also be used.

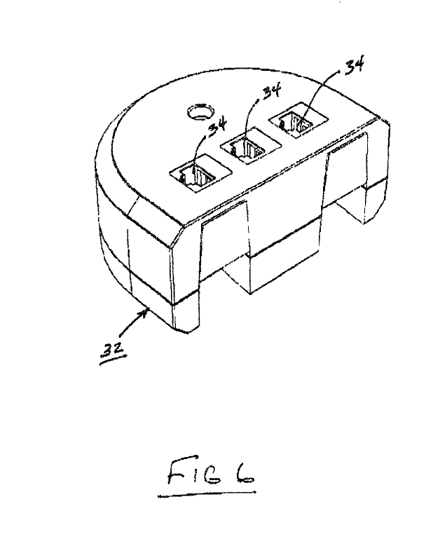

FIG. 7 illustrates another embodiment of the invention wherein the body structure 12 has the configuration of a bus bar. In the embodiment illustrated in FIG. 7, the body structure 12 comprises a first module unit 42 an electrical input element 14 consisting of an extension cord attached to the body structure 12 such that the electrical input element 14 can swivel. The first module unit 42 further comprises an on-off switch 26. Disposed within the first module 42 in the embodiment illustrated in FIG. 7 can be electrical circuitry commonly known in the art to provide the first module unit 42 with the capability to act as a surge suppressor. A second module unit 43 comprises a low voltage DC electrical female outlet 18. A third module unit 44 comprises a pair of standard AC electrical outlets 16. A fourth module 46 comprises a low voltage DC electrical female outlet 18 covered with a resilient cover 48. A fifth module unit 50 and a sixth module unit 52 comprise a pair of standard AC electrical outlets 16. A seventh module unit 54 comprises three telephone jack receptacles 34. Each of the module units 20 is connected to adjoining module units 20 by plug-and-socket connections.

In the embodiment illustrated in FIG. 8, the body structure 12 is configured as an extension cord having an electrical input element 14 in the form of a male AC electrical element at one end and a pair of female electrical connection elements at the other end. One of the two female electrical connection elements is a standard AC electrical outlet 16 connected in electrical communication with the electrical input element 14 at the opposite end of the body structure 12 and adapted to provide AC electricity to an electrical device 53 plugged into the standard AC electrical outlet 16. The other female electrical connector is a low voltage DC electrical female outlet 18 which is also connected in electrical communication with the electrical input element 14 disposed at the opposite end of the body structure 12. The low voltage DC electrical female outlet 18 is adapted to provide low voltage DC electricity to an electrical device 55 plugged into the low voltage DC electrical female outlet 18.

In the embodiment illustrated in FIGS. 9 and 10, the body structure 12 is configured as a light bulb socket having an electrical input element 14 configured as a male light bulb connection element 56. The body structure 12 further comprises a female light bulb socket 58. Disposed within the body structure 12 is a single standard AC outlet 16 connected in electrical communication with the male light bulb connection element 56 and adapted to provide AC electricity to an electrical device plugged into the standard AC electrical outlet 16. Also disposed within the light bulb structure 12 is a low voltage DC electrical female outlet 18 connected in electrical communication to the male light bulb connection element 56 and adapted to provide low voltage DC electricity to an electrical device plugged into the low voltage DC electrical female outlet 18.

In the embodiment illustrated in FIG. 11, the body structure 12 is an ordinary table lamp 59. Alternatively, the body structure 12 can be any other ordinary household or office consumer device 60 having a function unrelated to the charging of batteries. Such a consumer device can include luggage devices and consumer electrical devices 62. Luggage devices can include briefcases, suitcases and any of the many styles of other tote bags suitable for the transport of clothing or documents. Consumer electrical devices include, but are not necessary limited to, telephones, answering machines, fax machines, portable radios, alarm clocks, alarm radios, computers, computer monitors, computer keyboards, computer printers, laptop computers, computer scanners, lamps, televisions, refrigerators, coffee makers, stereos, tape decks, CD players, DVD players, palm pilot cradles and cable boxes. Each of these consumer electric devices has a primary electrically powered function unrelated to the charging of batteries. As illustrated in FIG. 11, the body structure 12 comprises a table lamp 59 whose primary electrical function is that of providing light to the consumer. In this embodiment of the invention, the DC electrical female outlet 18 is a necessary component of the invention, but the standard AC electrical outlet 16 is optional.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A combination comprising:
(a) a body structure;
(b) an electrical input element for connecting the body structure to a source of alternating current electricity;
(c) a standard AC electrical outlet disposed within the body structure, the standard AC electrical outlet being connected in electrical communication with the electrical input element and being adapted to provide AC electricity to an electrical device plugged into the standard AC electrical outlet when the electrical input element is electrically connected to a source of electrical power; and
(d) a low voltage DC electrical female outlet disposed within the body structure being connected in electrical communication with the electrical input element and adapted to provide low voltage DC electricity to an electrical device plugged into the low voltage DC electrical female outlet when the electrical input element is electrically connected to a source of electrical power.

2. The combination of claim 1 wherein the standard AC electrical outlet is a female electrical outlet.

3. The combination of claim 1 wherein the body structure is a bus bar.

4. The combination of claim 1 wherein the body structure comprises a surge suppressor.

5. The combination of claim 1 wherein the electrical input element comprises a male light bulb connection element.

6. The combination of claim 5 wherein the body structure comprises a female light bulb socket.

7. The combination of claim 1 wherein the body structure is an extension cord.

8. The combination of claim 3 wherein the electrical input element is an extension cord which is swivably attached to the body structure.

9. The combination of claim 1 wherein the body structure is comprised of a plurality of module units, each module unit being electrically and physically attached to each adjoining module unit by plug-and-socket connections.

10. The combination of claim 9 wherein the plurality of module units comprises a module unit having an on-off switch.

11. The combination of claim 9 wherein the plurality of module units comprises a module unit having a plurality of telephone jack receptacles.

12. A combination comprising:
(a) a body structure configured as a bus bar, the body structure comprising a surge suppressor, the body structure also comprising a plurality of module units, each module unit being electrically and physically attached to each adjoining module unit by plug-and-socket connections, the plurality of module units comprising a module unit having an on-off switch;
(b) an electrical input element for connecting the body structure to a source of alternating current electricity;
(c) a standard AC electrical female outlet disposed within the body structure, the standard AC electrical outlet being connected in electrical communication with the electrical input element and being adapted to provide AC electricity to an electrical device plugged into the standard AC electrical outlet when the electrical input element is electrically connected to a source of electrical power; and
(d) a low voltage DC electrical female outlet disposed within the body structure being connected in electrical communication with the electrical input element and adapted to provide low voltage DC electricity to an electrical device plugged into the low voltage DC electrical female outlet when the electrical input element is electrically connected to a source of electrical power.

13. The combination of claim 12 wherein the electrical input element is an extension cord which is swivably attached to the body structure.

14. The combination of claim 12 wherein the plurality of module units comprises a module unit having a plurality of telephone jack receptacles.

15. A combination comprising:
(a) a body structure in the form of a consumer device having a primary function unrelated to the charging of batteries;
(b) an electrical input element for connecting the body structure to a source of alternating current electricity; and
(c) a low voltage DC electrical female outlet disposed within the body structure being connected in electrical communication with the electrical input element and adapted to provide low voltage DC electricity to an electrical device plugged into the low voltage DC electrical female outlet when the electrical input element is electrically connected to a source of electrical power.

16. The combination of claim 15 wherein the consumer device is a consumer electrical device.

17. A combination comprising:
(a) a body structure chosen from the group of body structures consisting of telephones, answering machines, fax machines, portable radios, alarm clocks, alarm radios, computers, computer monitors, computer keyboards, computer printers, laptop computers, computer scanners, lamps, televisions, refrigerators, coffee makers, stereos, tape decks, CD players, DVD players, palm pilot cradles and cable boxes
(b) an electrical input element for connecting the body structure to a source of alternating current electricity; and
(c) a low voltage DC electrical female outlet disposed within the body structure being connected in electrical communication with the electrical input element and adapted to provide low voltage DC electricity to an electrical device plugged into the low voltage DC electrical female outlet when the electrical input element is electrically connected to a source of electrical power.
